(19) United States
(12) Patent Application Publication
(10) Pub. No.: US 2007/0078632 A1
(43) Pub. Date: Apr. 5, 2007

(54) Stress balanced cutting structure

(75) Inventors: Yuelin Shen, Houston, TX (US); Youhe Zhang, Tomball, TX (US); John L. Williams, The Woodlands, TX (US); Peter Thomas Cariveau, Spring, TX (US); Michael J. Janssen, The Woodlands, TX (US)

Correspondence Address: OSHA LIANG L.L.P., 1221 MCKINNEY STREET, SUITE 2800, HOUSTON, TX, 77010, US

(73) Assignee: Smith International, Inc., Houston, TX (US)

(21) Appl. No.: 11/198,408

(22) Filed: Aug. 5, 2005

(51) Int. Cl. G06F 17/50

(52) U.S. Cl. 703/1

(57) ABSTRACT

A method for designing a drill bit including selecting a characteristic associated with a failure mode. A first value of the characteristic of a first cutting element and a second value for the characteristic of a second cutting element are determined. The method also includes determining whether a difference between the first value and the second value is within a predetermined range. A cutting element design parameter for the first cutting element is adjusted if the difference is outside the predetermined range. The determining first and second values, determining the difference, and adjusting a cutting element design parameter are repeated until the difference is within the predetermined range.

### BACKGROUND OF INVENTION

1. Field of the Invention

The invention relates generally to fixed cutter drill bits.

2. Background Art

In drilling a borehole in the earth, such as for the recovery of hydrocarbons, minerals, or for other applications, it is conventional practice to connect a drill bit on the lower end of an assembly of drill pipe sections which are connected end-to-end so as to form a “drill string.” The drill string is rotated by an apparatus that is positioned on a drilling platform located at the surface of the borehole. Such an apparatus turns the bit and advances it downwardly, causing the bit to cut through the formation material by either abrasion, fracturing, shearing action, or through a combination of all such cutting methods. While the bit is rotated, drilling fluid is pumped through the drill string and directed out of the drill bit through nozzles that are positioned in the bit face. The drilling fluid is provided to cool the bit and to flush cuttings away from the cutting structure of the bit. The drilling fluid forces the cuttings from the bottom of the borehole and carries them to the surface through the annulus that is formed between the drill string and the borehole. FIG. 1 shows one example of a conventional drilling system drilling an earth formation. The drilling system includes a drilling rig 2 used to turn a drill string 4, which extends downward into a well bore 6. Connected to the end of the drill string 4 is a drill bit 8, shown in further detail in FIG. 2.

Many different types of drill bits and bit cutting structures have been developed and found useful in various drilling applications. Such bits include fixed cutter bits and roller cone bits. The types of cutting structures include steel teeth, tungsten carbide inserts (“TCI”), polycrystalline diamond compacts (“PDC's”), and natural diamond. The selection of the appropriate bit and cutting structure for a given application depends upon many factors. One of the most important of these factors is the type of formation that is to be drilled, and more particularly, the hardness of the formation that will be encountered. Another important consideration is the range of hardnesses that will be encountered when drilling through different layers or strata of formation material.

Depending upon formation hardness, certain combinations of the above-described bit types and cutting structures will work more efficiently and effectively against the formation than others. For example, a milled tooth roller cone bit generally drills relatively quickly and effectively in soft formations, such as those typically encountered at shallow depths. By contrast, milled tooth roller cone bits are relatively ineffective in hard rock formations as may be encountered at greater depths. For drilling through such hard formations, roller cone bits having TCI cutting structures have proven to be very effective. For certain hard formations, fixed cutter bits having a natural diamond cutting structure provide the best combination of penetration rate and durability. In formations of soft and medium hardness, fixed cutter bits having a PDC cutting structure are commonly employed.

Drilling a borehole for the recovery of hydrocarbons or minerals is typically very expensive due to the high cost of the equipment and personnel that are required to safely and effectively drill to the desired depth and location. The total drilling cost is proportional to the length of time it takes to drill the borehole. The drilling time, in turn, is greatly affected by the rate of penetration (ROP) of the drill bit and the number of times the drill bit must be changed in the course of drilling. A bit may need to be changed because of wear or breakage, or to substitute a bit that is better able to penetrate a particular formation. Each time the bit is changed, the entire drill string, which may be miles long, must be retrieved from the borehole, section by section. Once the drill string has been retrieved and the new bit installed, the bit must be lowered to the bottom of the borehole on the drill string which must be reconstructed again, section by section. As is thus obvious, this process, known as a “trip” of the drill string, requires considerable time, effort, and expense. Accordingly, because drilling cost is so time dependent, it is desirable to employ drill bits that will drill faster and longer and that are usable over a wider range of differing formation hardnesses.

The length of time that a drill bit may be employed before the drill string must be tripped and the bit changed depends upon the bit's rate of penetration (“ROP”), as well as its durability, that is, its ability to maintain a high or acceptable ROP. Additionally, a desirable characteristic of the bit is that it be “stable” and resist vibration, the most severe type or mode of which is “whirl.” Whirl is a term used to describe the phenomenon where a drill bit rotates at the bottom of the borehole about a rotational axis that is offset from the geometric center of the drill bit. Such whirling subjects the cutting elements on the bit to increased loading, which causes the premature wearing or destruction of the cutting elements and a loss of penetration rate.

An example of a prior art fixed cutter bit having a plurality of cutters with ultra hard working surfaces is shown in FIG. 2. The drill bit 10 includes a bit body 12 and a plurality of blades 14 that are formed on the bit body 12. The blades 14 are separated by channels or gaps 16 that enable drilling fluid to flow between, both cleaning and cooling, the blades 14 and cutters 18. Cutters 18 are held in the blades 14 at predetermined angular orientations and radial locations to present working surfaces 20 with a desired back rake angle against a formation to be drilled. Typically, the working surfaces 20 are generally perpendicular to the axis 19 and side surface 21 of a cylindrical cutter 18. Thus the working surface 20 and the side surface 21 meet or intersect to form a circumferential cutting edge 22. Nozzles 23 are typically formed in the drill bit body 12 and positioned in the gaps 16 so that fluid can be pumped to discharge drilling fluid in selected directions and at selected rates of flow between the cutting blades 14 for lubricating and cooling the drill bit 10, the blades 14 and the cutters 18. The drilling fluid also cleans and removes the cuttings as the drill bit rotates and penetrates the geological formation. The gaps 16, which may be referred to as “fluid courses,” are positioned to provide additional flow channels for drilling fluid, and to provide a passage for formation cuttings to travel past the drill bit 10 toward the surface of a wellbore (not shown).

The drill bit 10 includes a shank 24 and a crown 26. Shank 24 is typically formed of steel or a matrix material and includes a threaded pin 28 for attachment to a drill string. Crown 26 has a cutting face 30 and outer side surface 32. The particular materials used to form drill bit bodies are selected to provide adequate toughness, while providing good resistance to abrasive and erosive wear. For example, in the case where an ultra hard cutting element is to be used, the bit body 12 may be made from powdered tungsten carbide (WC) infiltrated with a binder alloy within a suitable mold form. In one manufacturing process the crown 26 includes a plurality of holes or pockets 34 that are sized and shaped to receive a corresponding plurality of cutters 18. The combined plurality of cutting edges 22 of the cutters 18 effectively forms the cutting face of the drill bit 10. Once the crown 26 is formed, the cutters 18 are positioned in the pockets 34 and affixed by any suitable method, such as brazing, adhesive, mechanical means such as interference fit, or the like. The design depicted provides the pockets 34 inclined with respect to the surface of the crown 26. The pockets are inclined such that cutters 18 are oriented with the working face 20 generally perpendicular to the axis 19 of the cutter 18 and at a desired rake angle in the direction of rotation of the bit 10, so as to enhance cutting. It will be understood that in an alternative construction (not shown), the cutting element can each be substantially perpendicular to the surface of the crown, while an ultra hard surface is affixed to a substrate at an angle on a cutter body or a stud so that a desired rake angle is achieved at the working surface.

In recent years, the PDC bit has become an industry standard for cutting formations of soft and medium hardnesses. The cutting elements used in such bits are formed of extremely hard materials and include a layer of polycrystalline diamond material. In the typical PDC bit, each cutter element or assembly comprises an elongate and generally cylindrical support member which is received and secured in a pocket formed in the surface of the bit body. A hard cutting layer of polycrystalline diamond is bonded to the exposed end of the support member, which is typically formed of tungsten carbide.

A common arrangement of the PDC cutting elements was to place them in a spiral configuration along the bit face. More specifically, the cutting elements were placed at selected radial positions with respect to the central axis of the bit, with each element being placed at a slightly more remote radial position than the preceding element. So positioned, the path of all but the center-most elements partly overlapped the path of travel of a preceding cutting element as the bit was rotated.

Although the spiral arrangement was once widely employed, this arrangement of cutting elements was found to wear in a manner to cause the bit to assume a cutting profile that presented a relatively flat and single continuous cutting edge from one element to the next. Not only did this decrease the ROP that the bit could provide, but it also increased the likelihood of bit vibration or instability which can lead to premature wearing or destruction of the cutting elements and a loss of penetration rate. All of these conditions are undesirable. A low ROP increases drilling time and cost, and may necessitate a costly trip of the drill string in order to replace the dull bit with a new bit. Excessive bit vibration may dull or damage the bit to an extent that a premature trip of the drill string becomes necessary.

Another common arrangement of PDC cutting elements used today is to place the cutting elements in a trailing design. A trailing design, or plural set, has more than one cutting element at a given radius. A trailing design, therefore, includes trailing cutting elements that follow in the same groove as the leading cutting element as the bit drills, without other cutting elements at different radial positions compromising the groove. Trailing designs provide the bit mechanical stability. However, having both cutting elements on the same profile causes the leading cutting element to experience much higher work rate and forces than the trailing cutting element. For example, FIG. 3 shows a conventional trailing design, with leading cutting element 110 and the trailing cutting element 112. The leading cutting element 110 makes contact with the formation 114, and the trailing cutting element 112 follows in the same groove 116 as the leading cutting element 110. Thus, the leading cutting element 110 experiences greater force and has a higher work rate and stress load than the trailing cutting element 112. This results in a fast, yet fragile cutting structure. On traditional bits, for example, in a single set (where multiple cutting elements are not at the same given radius), or opposing cutting structure, the forces may be essentially equalized. A single set with essentially equalized forces may result in a more durable cutting structure, but the structure is mechanically less stable.

Fixed cutter bits have been made, see for example U.S. Pat. No. 5,549,171, which is assigned to the assignee of the instant application and is incorporated by reference in its entirety, that include sets of cutting elements mounted on the bit face, wherein each set includes at least two cutting elements mounted on different blades at generally the same radial position with respect to the bit axis, but having differing degrees of backrake. The cutting elements of a set may be mounted having their cutting faces out-of-profile, such that certain elements in the set are exposed to the formation material to a greater extent than other cutting elements in the same set. The cutting elements in a set may have cutting faces and profiles that are identical, or they may vary in size or shape or both.

Additionally, other fixed cutter drill bits, see for example U.S. Pat. No. 5,607,025, which is assigned to the assignee of the instant application and is incorporated by reference in its entirety, include cutting elements mounted in sets on the bit face, wherein a cutting element set includes cutting elements with cutting faces having at least two different curvatures. The cutting elements of the set are mounted on various blades of the bit such that, in rotated profile, the cutting profile of a larger and a smaller cutting element overlap, and such that the smaller cutting element is flanked by larger sized cutting elements. In bits where smaller and larger cutting elements are mounted on the bit, the smaller cutting elements experience higher stresses and usually fail before the larger cutting elements. That is, the life of the smaller cutting elements may limit the durability and life of the bit.

Drill bit life and efficiency are of great importance because the rate of penetration of the bit through earth formations is related to the failure rate of the cutting elements on the bit. Failure of cutting elements may be a result of, for example, impact loading on the cutting elements, wear induced on the elements, the work rate of the cutting elements, stress on the cutting elements, etc. Accordingly, various methods have been used to provide failure protection for drill bits in general, and specifically for PDC bits and cutting elements. For example, to prevent or reduce abrasion or wear, cutting elements, and other bit surfaces may be coated with hardfacing material to provide more abrasion resistant surfaces. Further, specialized cutting element insert materials have been developed to optimize longevity of the cutting elements. While these methods of protection have met with some success, drill bits still experience cutting element failure.

Thus, fixed cutter drill bits are desired that can improve the mechanical stability, durability, and life of the cutting structure.

### SUMMARY OF INVENTION

In one aspect, the invention provides a method to design a drill bit. In one aspect, the method includes selecting a characteristic associated with a failure mode, determining a first value of the characteristic of a first cutting element and a second value for the characteristic of a second cutting element, and determining whether a difference between the first value and the second value is within a predetermined range. A cutting element design parameter for the first cutting element is adjusted if the difference is outside the predetermined range. The determining first and second values, determining the difference, and adjusting a cutting element design parameter are repeated until the difference is within the predetermined range.

In another aspect, the invention provides a method to design a drill bit, the method including selecting a characteristic associated with a failure mode, determining a value of the characteristic of each of a plurality of cutting elements, determining whether a variation of the values is within a predetermined range, adjusting a cutting element design parameter of at least one cutting element if the variation is outside the predetermined range, repeating the determining a value, determining whether a variation is within a predetermined range, and adjusting a cutting element design parameter until the variation is within the predetermined range.

In another aspect, the invention provides a drill bit comprising a bit body and a bit face on the bit body. A first cutting element and a second cutting element are disposed on the bit face, wherein a difference between a first value of a characteristic associated with a failure mode of the first cutting element and a second value of a characteristic associated with a failure mode of the second cutting element is within a predetermined range.

In another aspect, the invention provides a drill bit designed by a method that includes selecting a characteristic associated with a failure mode, determining a first value of the characteristic of a first cutting element and a second value for the characteristic of a second cutting element, and determining whether a difference between the first value and the second value is within a predetermined range. A cutting element design parameter for the first cutting element is adjusted if the difference is outside the predetermined range. The determining first and second values, determining the difference, and adjusting a cutting element design parameter are repeated until the difference is within the predetermined range.

Other aspects and advantages of the invention will be apparent from the following description and the appended claims.

### BRIEF DESCRIPTION OF DRAWINGS

FIG. 1 shows a schematic diagram of a drilling system for drilling earth formations having a drill string attached at one end to a fixed cutter drill bit.

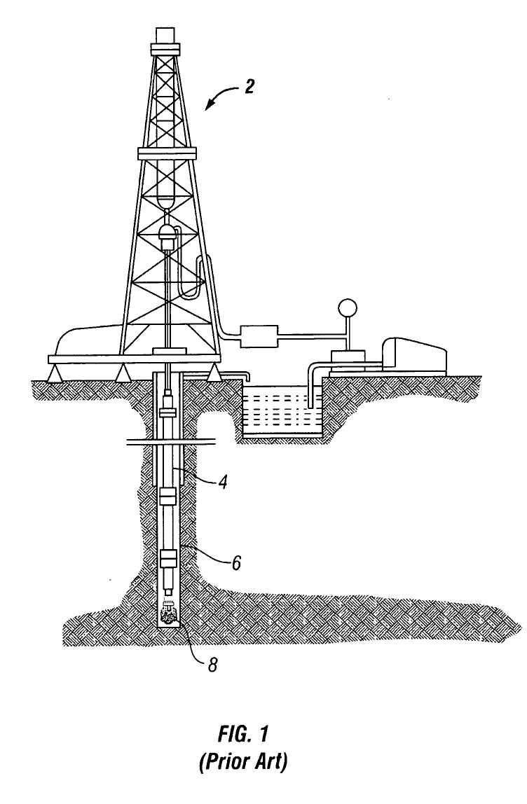

FIG. 2 is a perspective view of a prior art fixed cutter drill bit.

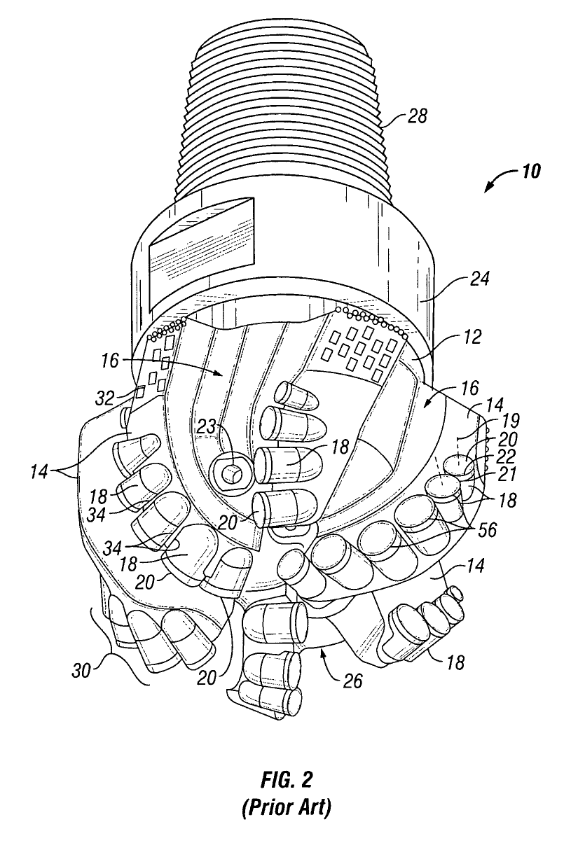

FIG. 3 shows a schematic of a conventional trailing cutter design.

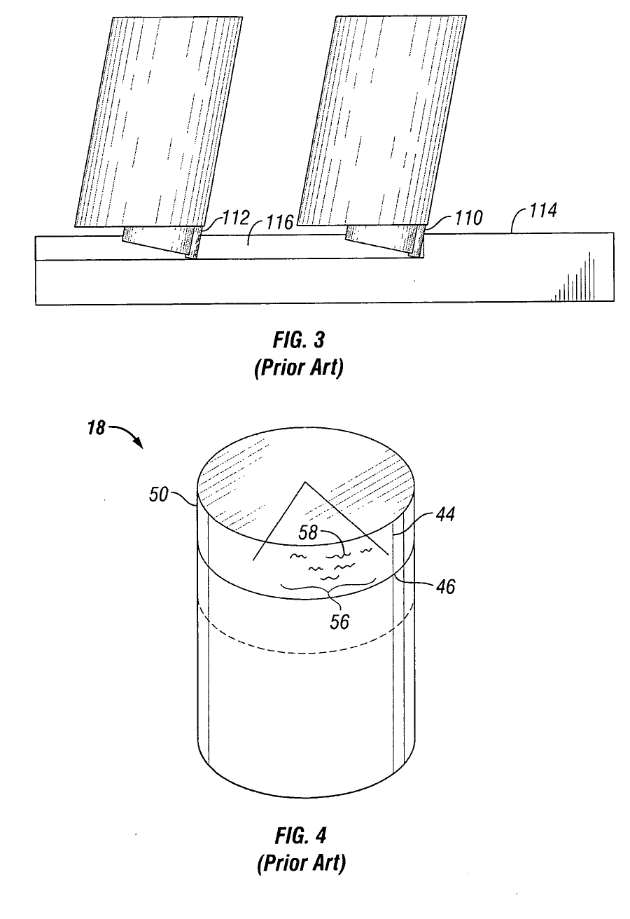

FIG. 4 is a perspective view of a prior art cutting element with an ultra hard layer bonded to a substrate or stud.

FIG. 5 is a plan view of a cutting end of a drill bit in accordance with an embodiment of the invention.

FIG. 6 is an enlarged view of a portion of FIG. 5 showing, in rotated profile, the cutting profile of a set of cutting elements in accordance with an embodiment of the invention.

FIG. 7 shows a schematic of cutting elements in contact with a formation in accordance with an embodiment of the invention.

FIG. 8 is a perspective view of a drill bit made in accordance with an embodiment of the invention.

FIG. 9 is a plan view of the cutting end of the drill bit shown in FIG. 8

FIG. 10 shows a schematic of a trailing cutting element design in accordance with an embodiment of the invention.

FIGS. 11A-11F show plotted outputs of force and work rate at different cutting element radial positions for drill bit designs.

FIGS. 12a-12c show cutting elements with the same wear flat and back rake, but different diameters.

### DETAILED DESCRIPTION

During drilling, the life of a drill bit is often limited by the failure rate of the cutting elements mounted on the bit. Cutting elements may fail at different rates depending on a variety of factors. Such factors include, for example, the geometry of the cutting element, position of the cutting elements on the bit, the orientation of the cutting element with respect to the formation being drilled, cutting element material properties, etc. In one aspect, embodiments of the present invention relate to a method of designing a fixed cutter drill bit to maintain mechanical stability of the bit and control the failure rate of the cutting elements. In another aspect, embodiments of the present invention relate to a fixed cutter drill bit with cutting elements mounted thereon so as to reduce the difference or variation of characteristic values associated with a failure mode between at least two cutting elements until the variation is within a predetermined range.

Embodiments of the invention relate to fixed cutter drill bits and a method of designing a drill bit, wherein a characteristic associated with a failure mode is selected and a value for the characteristic is determined for at least two cutting elements. Cutting element design parameters of one or more of the cutting elements may be adjusted in order to reduce the difference or variation in the determined characteristic values of the cutting elements. The difference in the values of the characteristics associated with a failure mode between the at least two cutting elements is reduced so as to reduce the difference of failure rates of the at least two cutting elements. In one aspect, fixed cutter drill bits having cutting elements with a reduced difference of cutting element failure rates reduces the risk of certain cutting elements failing before others and necessitating the removal of the drill bit from the wellbore. In one embodiment, the difference of failure rates of the cutting elements may be reduced so that the cutting elements fail at approximately the same time.

As used herein, the term “characteristic associated with a failure mode” means a factor that characterizes the performance of cutting element, for example, force, stress, work rate, and/or wear rate of a cutting element, that may be used to determine a failure mode or a failure rate of a cutting element; “failure mode” means the cause of failure of a cutting element, for example, impact, wear, delamination, abrasion; “cutting element design parameter” means the factors that characterize the physical design of a cutting element, for example, the cutting element geometry, position of the cutting element on the blade or bit, orientation of the cutting element with respect to the formation being drilled, and material properties of the cutting element.

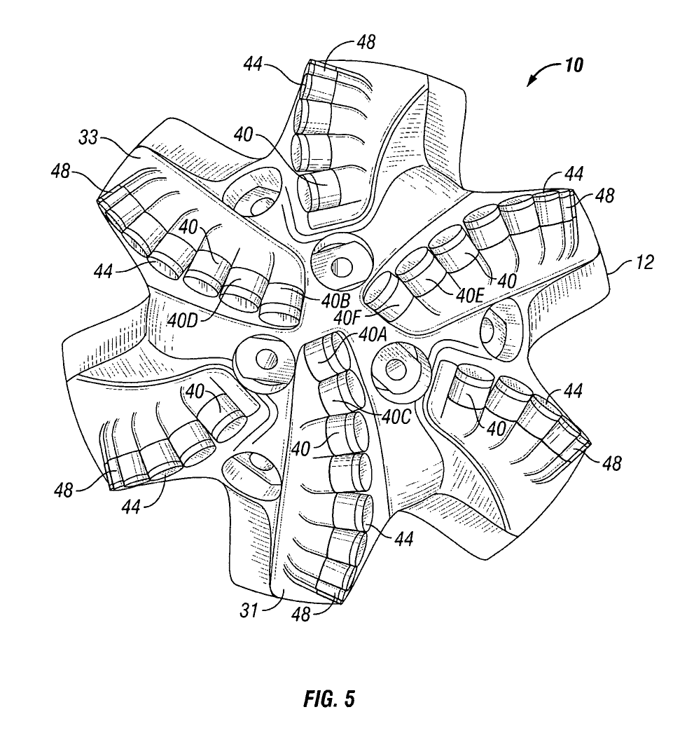

As a result of impact loading, wear, and stress during drilling, cutting elements may fail due to cracking, spalling, chipping and partial fracturing of the ultra hard material cutting layer at a region of cutting layer subjected to the highest loading during drilling. This region is referred to herein as the “critical region” 56, as shown in FIG. 4. The critical region 56 encompasses the portion of the cutting layer 44 that makes contact with the earth formations during drilling. The critical region 56 is subjected to the generation of high magnitude stresses from dynamic normal loading, and shear loadings imposed on the ultra hard material layer 44 during drilling. Because the cutting elements are typically inserted into a fixed cutter bit at a selected rake angle, the critical region includes a portion of the ultra hard material layer, near and including a portion of the layer's circumferential edge 22, that makes contact with the earth formations during drilling.

The high magnitude stresses at the critical region 56 alone or in combination with other factors, such as residual thermal stresses, can result in the initiation and growth of cracks 58 across the ultra hard layer 44 of the cutter 18. Cracks of sufficient length may cause the separation of a sufficiently large piece of ultra hard material, rendering the cutting element 18 ineffective or resulting in the failure of the cutter 18. When this happens, drilling operations may have to be ceased to allow for recovery of the drag bit and replacement of the ineffective or failed cutter. The high stresses, particularly shear stresses, can also result in delamination of the ultra hard layer 44 at the interface 46.

During drilling, it is often difficult to determine the number of cutting elements that have failed on a drill bit during drilling. Often, failure of cutting elements is marked by a decrease in the ROP of the drill bit. By designing a drill bit wherein the difference between the characteristic values associated with a failure mode of at least two cutting elements is reduced to within a predetermined range, the difference in the failure rates of the cutting elements may also be reduced. Therefore, a ROP of a drill bit that shows marked reduction may indicate that most of the cutting elements on the bit have failed. As a result, a more accurate estimate of when to remove the bit may be possible. In addition, drill bits of this type may have an increased longevity. Therefore, fewer trips to replace the drill bit are necessary, thereby reducing the time, effort, and expense to drill a wellbore.

In one embodiment, the characteristic associated with a failure mode is the stress on the cutting elements. The stress experienced by each individual cutting element depends on various cutting element design parameters. Cutting element design parameters may include, but are not limited to, cutting element geometry, position of the cutting element on the blade or bit, orientation of the cutting elements, and material properties. The geometry of a cutting element may include, for example, the diameter, the shape, and the bevel of the cutting element. The position of the cutting element may include, for example, the radial location of the cutting element on the bit face, the axial location of the cutting element on the bit face, cutting element spacing, and exposure height of the cutting element. The exposure height of the cutting element refers to the axial length of the cutting element that extends out from the bit face. The orientation of the cutting element may include, for example, the back rake, the side rake, and the rake angle of the cutting element. The stress experienced by each cutting element may be determined by finite element analysis (FEA), simulating the cutting elements contacting a formation, stress equations, or other analysis techniques known to those in the art, see for example U.S. Publication No. 2005-0080595, which is assigned to the assignee of the instant application and is incorporated by reference in its entirety. In one embodiment, the stress experienced by each cutting element may be determined by calculating the stresses caused by compressive forces that act along the axis of the cutting elements, stresses caused by the bending of the cutting element due to the forces that act perpendicular to the axis of the inserts, or a combination of the compressive and bending forces. The stress due to the compressive stress is a function of the force applied per the cross-sectional area perpendicular to the force. In other words the compressive load can be written as:

$${σ}_{cl} = \frac{F}{A} \qquad ( 1 )$$

where F is the applied force and A is the cross sectional area perpendicular to the applied force.

The stress due to bending places one side of the cutting element in tension and the other side of the cutting element in compression. This stress is a function of the bending moment of the cutting element times the radius of the cutting element at the root, that is, at the location where the cutting element meets the blade, per the moment of inertia at the cross section of the cutting element at the root, and it can be written as:

$${σ}_{b} = \frac{M * h}{I} \qquad ( 2 )$$

where M is the bending moment at the cutting element root, h is equal to the radius of the cutting element at the root, and I is the moment of inertia of the cross section of the cutting element at the root. The bending moment is caused by all forces perpendicular to the cutting element's axis.

The shear stress at the PDC and substrate interface is given by:

$${σ}_{s} = \frac{{F}_{s}}{{A}_{i}} \qquad ( 3 )$$

where Fₛ is the force component parallel to the interface and Aᵢ is the interface area. Shear stress is very harmful and may cause the cutter to delaminate at the interface.

A first cutting element experiencing a higher stress than a second cutting element is more likely to fail before the second cutting element fails. Thus, the difference in failure rates of the cutting elements may be reduced by adjusting the cutting element design parameters so as to reduce the difference in stress experienced by the cutting elements. The stress may be monitored in terms of the maximum stresses acting on the cutting elements, average stresses acting on the cutting elements, or some combination thereof. Moreover, in select embodiments, wear of the cutting elements may be modeled as wear may often affect the stress encountered by the cutting elements. The cutting element design parameters are adjusted so that the difference in the characteristic associated with a failure mode, for example, stress, between at least two cutting elements is reduced to within a predetermined range. The predetermined range may be determined, for example, empirically, or may be set by the designer. In one embodiment, the predetermined range for evaluating a characteristic associated with a failure mode may be in a range of less than 20% difference in values. In another embodiment, the predetermined range for evaluation a characteristic associated with a failure mode may be in a range of less than 10% difference in values. One of ordinary skill in the art will appreciate that any range deemed necessary for reducing the difference between the values of characteristics associated with a failure mode may be set.

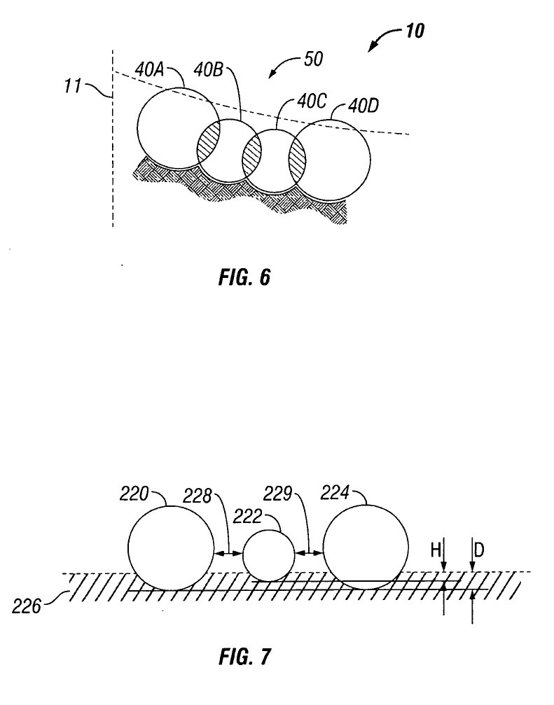

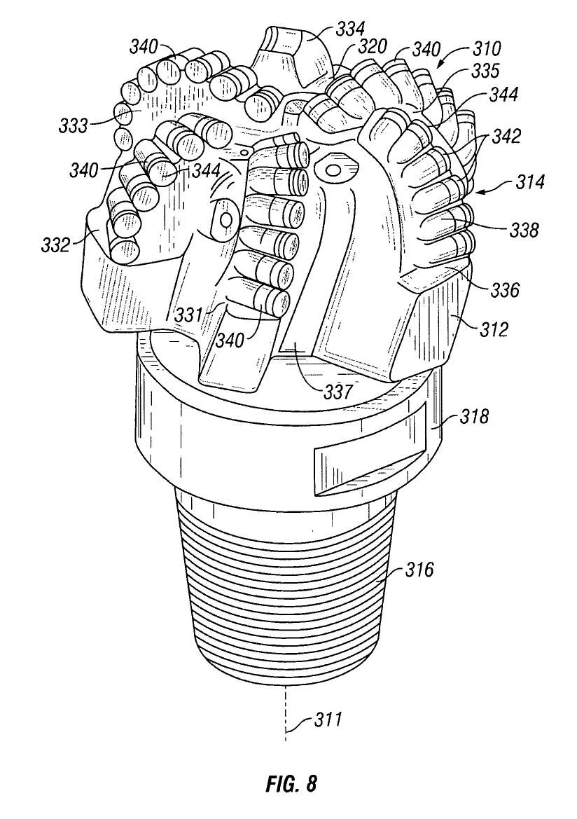

A cutter set 50, shown in FIG. 6 in rotated profile, comprises cutting elements 40a-d disposed on blades (31 and 33 of FIG. 5). As shown in FIG. 5, cutting elements 40a, 40c are radially spaced from one another and are mounted in a first row 48 on blade 31 on a drill bit 10. Cutting elements 40b, 40d are radially spaced from one another along a second row on blade 33. Cutting elements 40a-40d and their respective cutting faces 44 have different diameters and cutting profiles. In one embodiment, cutting elements 40a, 40d have cutting faces 44 which are larger in diameter than those of cutting elements 40b, 40c. While cutting elements 40a and 40d are shown here to have cutting faces larger in diameter than those of cutting elements 40b, 40c, it is understood that cutting elements 40a-40d may be of different diameters.

In this embodiment, the cutting elements with smaller diameters, or small cutting elements, experience higher stress than the large cutting elements, because the forces generated during drilling are acting over a smaller area on a small cutting element. Applicants have found through analysis that smaller cutting elements are subjected to higher stresses during drilling, especially when impact load is generated due to bit vibration. Therefore, smaller cutting elements set at the same depth of cut as larger cutting elements tend to fail before the larger cutting elements.

In accordance with embodiments of the invention, cutting element design parameters may be adjusted for smaller cutting elements in order to reduce the stress experienced by the smaller cutting elements in order to reduce the difference in stress experienced by all cutting elements on the bit, thereby reducing the difference in failure rates of the cutting elements.

In one embodiment, cutting element design parameters may be adjusted for smaller cutting elements in order to make the smaller cutting elements more resistant to stress. The smaller cutting elements may be formed, for example, from a tougher material in order to withstand the higher stress experienced by the smaller cutting elements in comparison to the large cutting elements. This adjustment of the material property of the cutting elements may reduce the difference in failure rates experienced by the smaller and larger cutting elements.

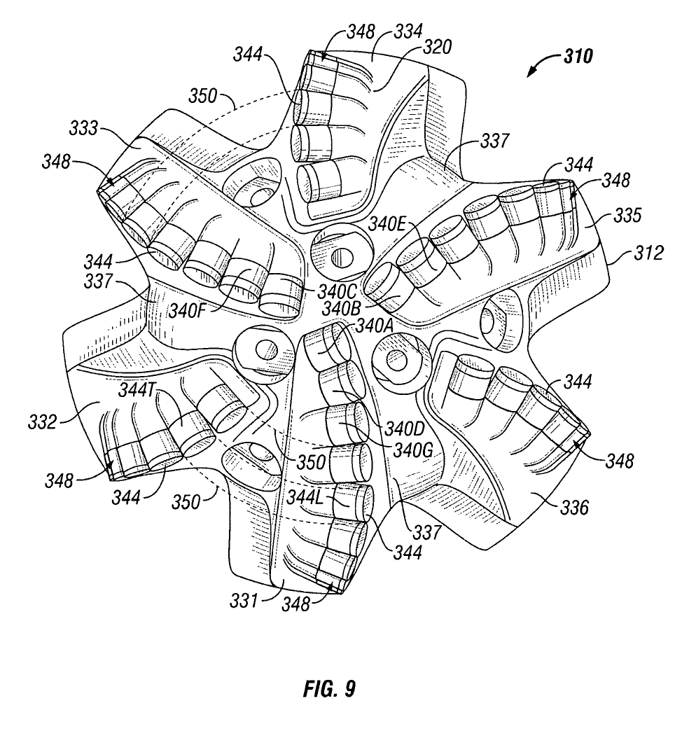

In another embodiment, the exposure height and/or back rake angle of the cutting elements of differently sized cutting elements may be adjusted to effectively reduce the difference in stress experienced by the smaller and larger cutting elements. By designing a smaller cutting element to have a smaller exposure height and/or a higher back rake angle, the stress experienced by the smaller cutting element may be reduced to a point so that the difference in stress between the smaller cutting element and the larger cutting element is reduced to within a predetermined range. FIG. 7 shows cutting elements 220, 222, 224 in contact with formation 226, according to an embodiment of the invention. In one embodiment, smaller cutting element 222 has a depth of penetration h, which is less than the depth of penetration d of larger cutting elements 220, 224. The exposure height or back rake angle of the smaller cutting element is adjusted so that the force per area (F/A), or stress, experienced by the smaller cutting element is reduced to within a predetermined range of difference when compared to the larger cutting element. Thus, smaller cutting element 222 experiences a reduced stress that is within the predetermined range of difference when compared with the stress experienced by larger cutting elements 220, 224.

In another embodiment, the cutting element design parameters may be adjusted by adjusting the position of the cutting elements. In one embodiment, the position of the cutting elements may be adjusted by adjusting the cutting element spacing between cutting elements of similar size or varying size to effectively reduce the difference in stress experienced by, for example, the smaller and larger cutting elements. The spacing between the cutting elements may be non-uniform. That is, as shown in FIG. 7, the spacing 228 between larger cutting element 220 and smaller cutting element 222 may be larger or smaller than the spacing 229 between smaller cutting element 222 and larger cutting element 224. By adjusting the spacing between the cutting elements so that the stress experienced by the smaller cutting element is reduced, the difference in stress between the smaller cutting element and the larger cutting element may be reduced to within a predetermined range.

In another embodiment, the characteristic associated with a failure mode is the work rate of the cutting elements. Cutting elements that have higher work rates are more likely to wear unevenly or fail prematurely. In one embodiment, the work rates of the cutting elements may be determined by FEA, simulation of the cutting elements contacting a formation, work rate equations, or other analysis techniques known to those in the art. The cutting element design parameters may then be adjusted so that the difference or variation in the characteristic associated with a failure mode, for example, work rate, between at least two cutting elements, is reduced to within a predetermined range. The predetermined range may be determined, for example, empirically, or may be set by the designer. In one embodiment, the predetermined range for evaluating a characteristic associated with a failure mode may be in a range of less than 20% difference in values. In another embodiment, the predetermined range for evaluation a characteristic associated with a failure mode may be in a range of less than 10% difference in values. One of ordinary skill in the art will appreciate that any range deemed necessary to reduce the difference between the values of characteristics associated with a failure mode may be set. By reducing the difference in the characteristic values, for example the work rates of the cutting elements, the difference in failure rates between cutting elements may also be reduced.

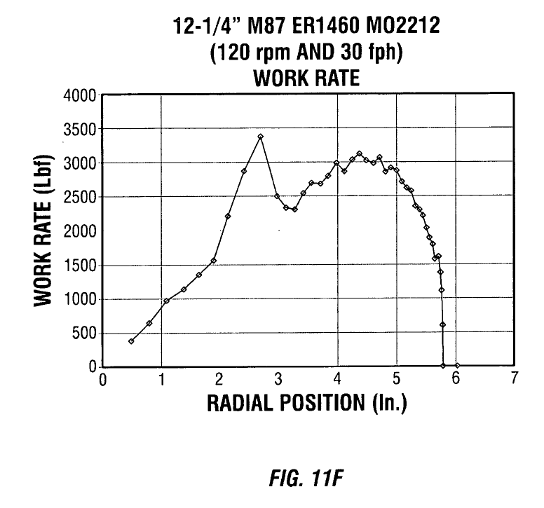

FIGS. 11A-11F show the relation between certain performance parameters and radial position of a cutting element for different drill bit designs. FIG. 11A shows the typical relationship between the force on a cutting element and the radial position of a cutting element for a trailing cutting element design on a 16″ drill bit at 120 revolutions per minute (rpm) and 30 feet per hour (fph). The cutting element with the lower force, marked at T, is the trailing cutting element behind the leading cutting element which experiences a greater force, marked at L. FIG. 11B shows the typical relationship between the work rate of a cutting element and the radial position of a cutting element for a trailing cutting element design on the same bit as FIG. 11A, a 16″ drill bit at 120 rpm and 30 fph. The cutting element with the smaller work rate, marked at T, is the trailing cutting element behind the leading cutting element which has a greater work rate, marked at L. In accordance with an embodiment of the invention, FIG. 11C shows the relationship between the force on a cutting element and the radial position of a cutting element for an opposing cutting element design on a 12¼″ drill bit at 120 rpm and 30 fph, wherein the difference between the force experienced by the leading cutting element, marked at L, and the force experienced by the trailing cutting element, marked at T, is reduced. In such an opposing cutting element design, the cutting elements have substantially the same radial position on the shoulder of the bit, however, the cutting elements are on two different blades that are on opposite sides of the bit. In accordance with an embodiment of the invention, FIG. 11D shows the relationship between the work rate of a cutting element and the radial position of a cutting element for an opposing cutting element design on the same drill bit as FIG. 11C, a 12¼″ drill bit at 120 rpm and 30 fph, wherein the difference between the work rate of the leading cutting element, marked at L, and the work rate of the trailing cutting element, marked at T, is reduced. FIG. 11E shows the relationship between the force on a cutting element and the radial position of a cutting element for a single set, or spiral, cutting element design on a 12¼″ drill bit at 120 rpm and 30 fph in accordance with an embodiment of the invention. FIG. 11F shows the relationship between the work rate of a cutting element and the radial position of a cutting element for a single set, or spiral, cutting element design on the same drill bit as FIG. 11E, a 12¼″ drill bit at 120 rpm and 30 fph, in accordance with an embodiment of the invention.

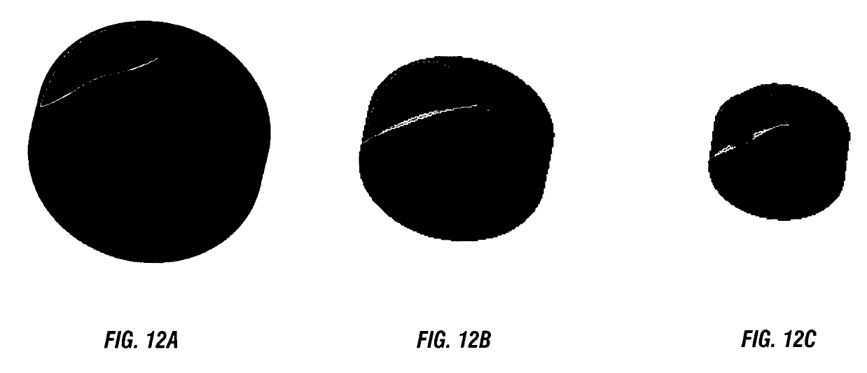

As mentioned above, as a bit is damaged by, for example, wear, its cutting profile may change. One notable effect of the change in cutting profile is that the bit drills a smaller diameter hole than when new. Changes in the cutting profile and in gage diameter act to reduce the effectiveness and useful life of the bit. Other wear-related effects that are less visible also have a dramatic impact on drill bit performance. For example, as individual cutting elements experience different types of abrasive wear, they may wear at different rates. As a result, a load distribution between cutting elements may change over the life of the bit. These changes are undesirable and may cause certain rows of cutting elements to be exposed to a majority of axial loading. This in turn may cause further uneven wear and may perpetuate a cycle of uneven wear and premature bit failure. FIGS. 12a, 12b, and 12c show an example of how cutting element size may affect the difference in failure rates between cutting elements. FIG. 12a shows a cutting element with a diameter of 19 mm, FIG. 12b shows a cutting element with a diameter of 16 mm, and FIG. 12c shows a cutting element with a diameter of 13 mm. Each of the three cutting elements of FIGS. 12a, b, and c have a wear flat, or area of wear, of 0.08 in². For cutting elements with the same wear flat and the same back rake, but different diameters, the cutting elements with a smaller diameter are more susceptible to failure than the cutting elements with a larger element due to the higher force per unit area, or stress, experienced by the smaller cutting element with respect to the larger cutting element.

The wear rate of at least two cutting element may be determined by FEA, simulation of the cutting elements contacting a formation, wear equations, or other analysis techniques known to those in the art, see for example U.S. Pat. No. 6,619,411 or U.S. Publication No. 2005-0015229, both assigned to the assignee of the instant application and both incorporated by reference in their entireties. The cutting element design parameters may then be adjusted so that the difference or variation in the characteristic associated with a failure mode, for example, wear, between at least two cutting elements is reduced to within a predetermined range. For example, the back rake angle of at least one cutting element may be increased so as to make the cutting element more wear resistant, thereby reducing the difference in value of the characteristic associated with a failure mode, in this case wear, between the at least two cutting elements. The predetermined range may be determined, for example, empirically, or may be set by the designer. In one embodiment, the predetermined range for evaluating a characteristic associated with a failure mode may be in a range of less than 20% difference in values. In another embodiment, the predetermined range for evaluation a characteristic associated with a failure mode may be in a range of less than 10% difference in values. One of ordinary skill in the art will appreciate that any range deemed necessary for reducing the difference between the values of characteristics associated with a failure mode may be set. Thus, in one embodiment, the difference in wear between at least two cutting elements may be reduced to within a predetermined range. Additionally, a difference in failure rate of at least two cutting elements may be reduced. In other words, in one embodiment, the design parameters of the cutting elements are selected to reduce the difference in wear between cutting elements to with in a predetermined range.

In accordance with embodiments of the invention, cutting element design parameters may be adjusted for smaller cutting elements to reduce the wear experienced by the smaller cutting elements or make the smaller cutting element more resistant to wear. A smaller cutting element more resistant to wear may reduce the difference in wear experienced between the smaller and larger cutting elements, thereby reducing the difference in failure rates of the cutting elements.

In one embodiment, cutting element design parameters may be adjusted for smaller cutting elements in order to make the smaller cutting elements more resistant to wear. The smaller cutting elements may be formed, for example, from a tougher material in order to withstand the wear experienced by the small cutting elements in comparison to the larger cutting elements. This adjustment of the material property of the cutting elements may reduce the difference in failure rates experienced by the smaller and larger cutting elements.

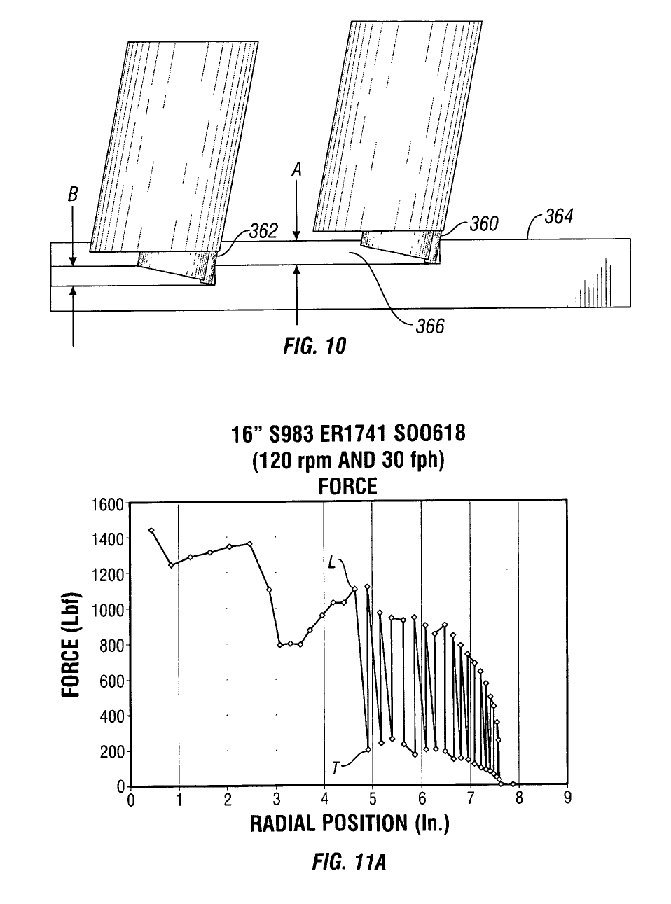

FIG. 8 shows a fixed cutter drill bit 310 formed in accordance with an embodiment of the invention. Bit body 318 includes a bit face 320 formed on the end of the bit 310 that is opposite pin 316 and which supports cutting structure 314. Body 318 may be formed in a conventional manner using powdered metal tungsten carbide particles in a binder material to form a hard metal cast matrix. Steel bodied bits, i.e., those machined from a steel block rather than a formed matrix, may also be employed. In one embodiment, bit face 320 includes six angularly spaced-apart blades 331-336 that are integrally formed as part of and extend from body 318. Blades 331-336 extend radially across the bit face 320 and longitudinally along a portion of the periphery of the bit. Blades 331-336 are separated by grooves 337 that define drilling fluid flow courses between and along the cutting faces 344 of the cutting elements 340, mounted on bit face 320. In one embodiment, blades 331, 333, and 335, are equally spaced 120° apart, while blades 332, 334, and 336 lag behind blades 331, 333, and 335 by 55°. Given this angular spacing, these blades may be considered as having pairs of “leading” and “trailing” blades, wherein a first pair comprises blades 331 and 332, a second pair comprises blades 333 and 334, and a third pair comprises blades 335 and 336.

As shown in FIG. 8, each cutting element 340 is mounted within a pocket 338 that is formed in the bit face 320 on one of the radially and longitudinally extending blades 331-336. Cutting elements 340 are constructed by conventional methods. Each cutting element 340 typically includes a generally cylindrical base or support 342, one end of which is secured within a pocket 338 by brazing or other means. The support 342 may be comprised of a sintered tungsten carbide material having a hardness greater than that of the body matrix material. Attached to the opposite end of the support 342 is a layer of ultrahard material, such as a synthetic polycrystalline diamond material, which forms the cutting element face 344 of element 340.

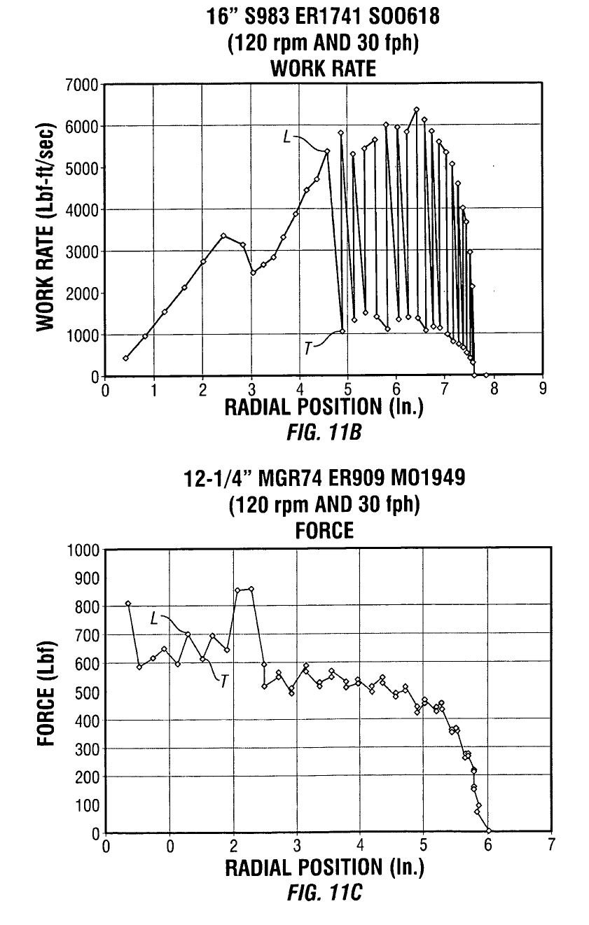

As shown in FIGS. 8 and 9, the cutting elements 340 are arranged in separate rows 348 along the blades 331-336 and are positioned along the bit face 320 in regions identified as the central portion, the shoulder, and gage portion. The cutting faces 344 of the cutting elements 340 are oriented in the direction of rotation of the drill bit 310 so that the cutting face 344 of each cutting element 340 engages the earth formation as the bit 310 is rotated and forced downwardly through the formation. Cutting elements 340 are mounted on the blades 331-336 in selected radial positions relative to the central axis 311 of the bit 310.

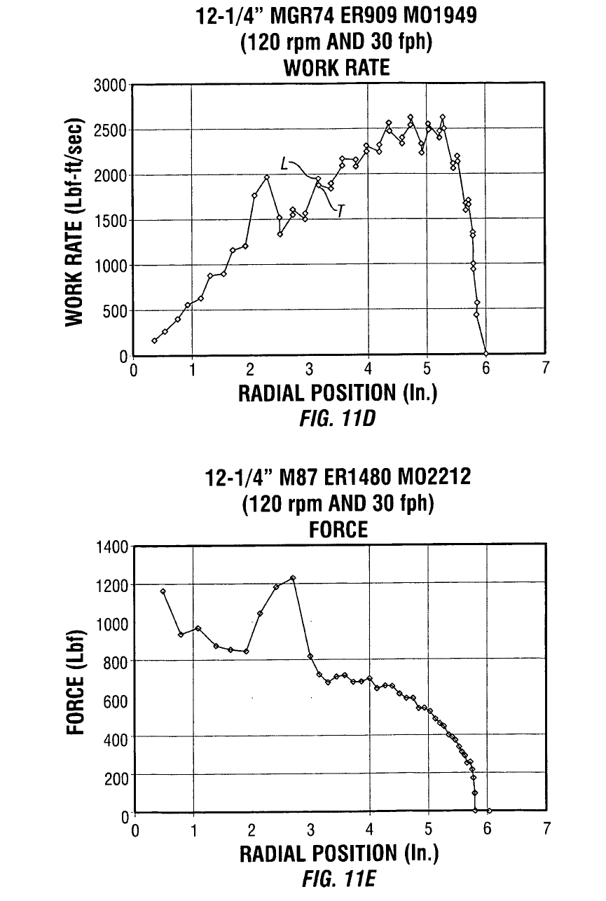

In one embodiment, cutting elements are grouped in sets comprising at least two cutting elements. The at least two cutting elements of a set are disposed on different blades at substantially the same radial position. The blades, on which the at least two cutting elements of a set are disposed, follow each other directly as they are positioned on the bit body. Referring to FIG. 9, in one embodiment, a leading cutting element 344L is disposed on blade 331, while a trailing cutting element 344T is disposed on blade 332. The leading cutting element 344L and the trailing cutting element 344T are arranged such that they follow the same radial path. In accordance with one embodiment of the invention, the trailing cutting element 344T is disposed on blade 332 at a position “above” the profile of the leading cutting element 344L. That is, the trailing cutting element 344T is positioned so as to have a greater exposure height, relative to the leading cutting element 344L. (See for example FIG. 10, as described below). Note that in certain embodiments, wherein a set comprises more than two cutting elements, each consecutive trailing cutting element may be disposed on a subsequent blade to extend above the profile of the preceding cutting element by a selected height.

As shown in FIG. 10, with this arrangement, the leading cutting element 360 makes contact with the formation 364 and forms a groove 366 of a depth a. The trailing cutting element 362 follows in the groove 366 of the leading cutting element 360, but also extends to the groove 366 by an amount indicated at b. Thus, the force experienced by the trailing cutting element 362 is increased in comparison to conventional trailing bit designs. Accordingly, the difference between the values of the characteristic associated with a failure mode, in this case force, of the leading and trailing cutting elements is reduced to within a predetermined range. As a result, the difference in the work rates of the leading and trailing cutting elements 360 and 362 is also reduced. In another embodiment, a set of cutting elements may include more than 2 cutting elements, whereby each consecutive trailing cutting elements may be positioned to further deepen the groove formed by the preceding cutting element by a selected depth. The exposure height, for example, may be selected and adjusted so as to reduce the stress, work rate, or wear between the leading and trailing cutting elements to within a predetermined range during drilling. Thus, the difference in failure rates between the leading and trailing cutting elements may also be reduced.

A bit having the design shown in FIGS. 9 and 10 retains the benefits of a trailing bit design in that such bits are more stable. In addition, a drill bit of the invention as shown in FIGS. 9 and 10 reduces the difference in work rates between the cutting elements to within a predetermined range. A bit having a design in accordance with the present invention may reduce the difference in force, stress, or wear between the cutting elements to within a predetermined range. Accordingly, a drill bit of the invention is expected to have enhanced performance and a longer life.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1-8. (canceled)

9. A method of designing a PDC drill bit, the method comprising:
(a) selecting a characteristic associated with a failure mode, wherein the characteristic is one selected from the group consisting of stress, work rate, and wear rate;
(b) determining a value of the characteristic of each of a plurality of cutting elements;
(c) determining whether a variation of the values is within a predetermined range;
(d) adjusting a cutting element design parameter of at least one cutting element if the variation is outside the predetermined range; and
(e) repeating steps (b)-(d) until the variation is within the predetermined range.

10. (canceled)

11. The method of claim 9, wherein the cutting element design parameter comprises at least one of material property, orientation, position, and geometry.

12. The method of claim 9, wherein the plurality of cutting elements comprise at least one set of cutting elements having a leading cutting element disposed on a first blade and a trailing cutting element disposed on a second blade.

13. The method of claim 12, wherein the trailing cutting element is positioned on the second blade so that it is positioned above the profile of the leading cutting element.

14. The method of claim 13, wherein the plurality of cutting elements comprises at least one smaller cutting element.

15. The method of claim 9, wherein the predetermined range is less than 20 percent variation.

16. The method of claim 9, wherein the predetermined range is less than 10 percent variation.

17-27. (canceled)

28. A method of designing a drill bit, the method comprising:
(a) selecting a characteristic associated with a failure mode;
(b) determining a first failure rate associated with the characteristic of a first cutting element and a second failure rate for the characteristic of a second cutting element;
(c) determining whether a difference between the first failure and the second failure rate is within a predetermined range;
(d) adjusting a cutting element design parameter for the first cutting element if the difference is outside the predetermined range; and
(e) repeating steps (b)-(d) until the difference is within the predetermined range.

29. The method of claim 28, wherein the characteristic associated with a failure mode is one selected from the group consisting of force, stress, work rate, and wear rate.

30. The method of claim 28, wherein the cutting element design parameter is material property.

31. The method of claim 28, wherein the predetermined range is less than 20 percent difference.

32. The method of claim 28, wherein the predetermined range is less than 10 percent difference.

33. A drill bit designed by the method of claim 1.
